(19) United States
(12) Patent Application Publication
(10) Pub. No.: US 2026/0295574 A1
(43) Pub. Date: Oct. 1, 2026

(54) REINFORCED NON-METALLIC FLUIDIC PROBE

(71) Applicant: IDEX HEALTH & SCIENCE LLC, OAK HARBOR, WA (US)

(72) Inventors: Seth Kettlewell, Oak Harbor, WA (US); Mark Hahn, Oak Harbor, WA (US); Gabriel Hill, Oak Harbor, WA (US); Travis Jeffries, Oak Harbor, WA (US)

(21) Appl. No.: 19/094,618

(22) Filed: Mar. 28, 2025

(51) Int. Cl. B01L 3/02

(52) U.S. Cl. CPC B01L 3/021; B01L 2300/0672

(57) ABSTRACT

A fluidic probe may include an elongate probe body, comprising a first end and a second end opposing the first end, wherein the first end defines a piercing tip, a first aperture formed in the elongate probe body proximate the piercing tip, and an inner channel extending between the first end and the second end, wherein the elongate probe body is formed of a metal-free polymer matrix and a non-metallic reinforcement material.

### CROSS REFERENCE TO RELATED APPLICATIONS

This application is related to U.S. Patent No. 9,056,264, issued to IDEX Health & Science LLC on Jun.16, 2015, and U.S. Application Serial No. 18/447,095, filed on Aug. 9, 2023, which are both hereby incorporated by reference in their entirety.

### FIELD

This invention relates generally to fluidic handling systems, and more specifically, to biocompatible fluidic probes used in connection with analytical instruments, biological processes and fluids, diagnostics, and the life sciences.

### BACKGROUND

Fluidic probes are used in a variety of applications, including healthcare, industrial processes, and scientific research, for example, in analytical instruments, biological processes and fluids, diagnostics, and the life sciences. These probes are generally designed to manipulate and monitor the flow of liquids in confined environments, including dispensing or aspirating fluids, often at microscales and nanoscales. For example, in biomedical applications, fluidic probes are essential for tasks such as cell sorting, drug delivery, and diagnostic testing, offering high precision and minimal invasiveness. In some examples, fluidic probes are used in low pressure analytical or diagnostic applications. For instance, fluidic probes may be used in low-pressure analytical or diagnostic instruments to precisely aspirate biological samples, such as blood plasma, from a microtiter plate and dispense them into reaction wells, using specialized fittings and tubing to ensure accuracy and prevent cross-contamination.

Fluidic probes often operate in demanding environments such as liquid chromatography (or gas, ion, or other chromatography systems or analytical instrument systems), including in corrosive conditions or conditions requiring prolonged use, necessitating designs that emphasize high strength and durability. For example, when a fluidic probe is used to pierce a fluidic container, high strength and durability are critical for preventing buckling and maintaining structural integrity, resisting wear, and performing reliably under mechanical stress or exposure to aggressive fluid. However, strength and durability must be balanced with the need for miniaturization and compatibility with delicate fluidic samples.

Moreover, some existing fluidic probes are made from a metal, such as stainless steel or nickel. However, while metals provide high strength, they often lack the compatibility with delicate fluidic samples, resulting in adverse reactions to the chemistry of some applications. More recently, it has been realized that the use of stainless-steel components in scientific instrumentations has potential drawbacks in situations involving biological samples or biological processes. For example, the components in a sample may attach themselves to the wall of stainless-steel tubing. This presents problems, for example, a detector’s measurements (and thus the results, such as a chromatogram in a liquid chromatography system) of a given sample may not accurately reflect the sample if some of the sample’s components or ions remain in the tubing, and do not pass the detector. Perhaps of even greater concern, however, is the fact that ions from the stainless-steel tubing may detach from the tubing and flow past the detector, thus leading to potentially erroneous results. Additionally, ions can easily bind to biological compounds of interest. Hence, there is a need for “biocompatible” devices through the use of a material that is chemically inert with respect to such “biological” samples and biological processes. Efforts have been made to coat metallic probes with a compatible inert layer, but doing so has presented significant challenges. For instance, coatings on small inner diameters are often uneven and inconsistent, frequently fail to meet the required levels of inertness, and introduce issues such as chemical resistance and potential surface interaction with reagents, making them a less viable solution.

Other existing probes may include a non-metallic material, such as polyetheretherketone (PEEK). However, although non-metallic materials may offer greater compatibility with delicate fluidic samples, they often lack the necessary strength required for optimal probe designs in certain applications, especially for probes with high length-to-diameter ratios. As a result, existing probes may also include metallic material (e.g. steel) to provide rigidity to the probe. This limitation becomes particularly apparent when designing probes with smaller diameters, where high strength and compatibility with delicate fluidic is critical.

### SUMMARY

Some embodiments of the present technology relate to a fluidic probe. The fluidic probe may include an elongate probe body. The elongate probe body may include a first end and a second end opposing the first end. The first end may define a piercing tip. The elongate probe body may include a first aperture formed in the elongate probe body proximate the piercing tip. The elongate probe body may include an inner channel extending between the first aperture in the first end and the second end of the elongate probe body. The elongate probe body may be formed of a metal-free polymer matrix and a non-metallic reinforcement material.

In some embodiments, the metal-free polymer matrix may be selected from the group consisting of polyetheretherketone (PEEK), polyaryletherketone (PAEK), polyetherketoneketone (PEKK), polysulfones (PSU, PESU, PPSU), polyamides (PA), polycarbonate (PC), acrylic polymers (PMMA), polyetherimide (PEI), polyimides (PI), polyamideimide (PAI), liquid crystal polymers (LCP), polyesters (PET, PETG, PBT), acetals (POM), polyphenylene polymers (PPS, PPE, PPO), thermosetting polymers (e.g., vinyl esters and epoxies), fluorinated ethylene propylene (FEP), ethylene tetrafluoroethylene (ETFE), polytetrafluoroethylene (PTFE), perfluoroalkoxy (PFA), perfluoroalkoxyethylene, polychlorotrifluoroethylene (PCTFE), polyethylene (PE), polypropylene (PP), polyvinylidene fluoride (PVDF), or combinations thereof. In some embodiments, the non-metallic reinforcement material may be selected from the group consisting of carbon fibers, glass fibers, basalt fibers, ceramics, talc, mica, or combinations thereof.

In some embodiments, the non-metallic reinforcement material may include between about 5% and about 70% by weight of the elongate probe body.

In some embodiments, the fluidic probe may further include a non-metallic connection system coupled to the elongate probe body proximate the second end and configured to removably couple the elongate probe body to a fluidic handling system.

In some embodiments, the elongate probe body may have a length of about 1/2 inch to about 12 inches, an outer diameter of about 1/4 inch or less, and an inner diameter of about 1/8 inch or less.

In some embodiments, the elongate probe body may have an outer diameter of between about 1/32 inch and about 1/4 inch.

In some embodiments, the elongate probe body may have an inner diameter of between about 1/100 inch and about 3/16 inch.

In some embodiments, the elongate probe body may include an inner body coupled to an outer body. The outer body may include the metal-free polymer matrix and the non-metallic reinforcement material. The inner body may define the inner channel through which a fluid may flow. The inner body may include an inert bio-compatible material. In some embodiments, the inner body may be at least partially insertable into a channel in the outer body. In some embodiments, the inert bio-compatible material may be selected from the group consisting of polyetheretherketone (PEEK), polyaryletherketone (PAEK), polyetherketoneketone (PEKK), polysulfones (PSU, PESU, PPSU), polyamides (PA), polycarbonate (PC), acrylic polymers (PMMA), polyetherimide (PEI), polyimides (PI), polyamideimide (PAI), liquid crystal polymers (LCP), polyesters (PET, PETG, PBT), acetals (POM), polyphenylene polymers (PPS, PPE, PPO), thermosetting polymers (e.g., vinyl esters and epoxies), fluorinated ethylene propylene (FEP), ethylene tetrafluoroethylene (ETFE), polytetrafluoroethylene (PTFE), perfluoroalkoxy (PFA), perfluoroalkoxyethylene, polychlorotrifluoroethylene (PCTFE), polyethylene (PE), polypropylene (PP), polyvinylidene fluoride (PVDF), or combinations thereof. In some embodiments, the non-metallic reinforcement material may be selected from the group consisting of carbon fibers, glass fibers, basalt fibers, ceramics, talc, mica, or combinations thereof.

In some embodiments, the elongate probe body may have a flexural strength of about 13 lbf, as determined by ASTM D790-17 three-point bend testing.

In some embodiments, the elongate probe body may tolerate a displacement of about 0.15 in before failure, as determined by ASTM D790-17 three-point bend testing.

Some embodiments of the present technology relate to a fluidic handling system. The fluidic handling system may include an elongate probe body removably coupled to a fluid handling structure. The elongate probe body may include a first end and a second end opposing the first end. The first end may define a piercing tip. The elongate probe body may include a first aperture formed in the elongate probe body proximate the piercing tip. The elongate probe body may include an inner channel extending between the first end and the second end. The elongate probe body may be formed of a metal-free polymer matrix and a non-metallic reinforcement material.

In some embodiments, the metal-free polymer matrix may be selected from the group consisting of polyetheretherketone (PEEK), polyaryletherketone (PAEK), polyetherketoneketone (PEKK), polysulfones (PSU, PESU, PPSU), polyamides (PA), polycarbonate (PC), acrylic polymers (PMMA), polyetherimide (PEI), polyimides (PI), polyamideimide (PAI), liquid crystal polymers (LCP), polyesters (PET, PETG, PBT), acetals (POM), polyphenylene polymers (PPS, PPE, PPO), thermosetting polymers (e.g., vinyl esters and epoxies), fluorinated ethylene propylene (FEP), ethylene tetrafluoroethylene (ETFE), polytetrafluoroethylene (PTFE), perfluoroalkoxy (PFA), perfluoroalkoxyethylene, polychlorotrifluoroethylene (PCTFE), polyethylene (PE), polypropylene (PP), polyvinylidene fluoride (PVDF), or combinations thereof. In some embodiments, the non-metallic reinforcement material may be selected from the group consisting of carbon fibers, glass fibers, basalt fibers, ceramics, talc, mica, or combinations thereof.

In some embodiments, the elongate probe body has a length of about 1/2 inch to about 12 inches, an outer diameter of about 1/4 inch or less, and an inner diameter of about 1/8 inch or less.

Some embodiments of the present technology relate to a method of fluidic handling. The method may include piercing a surface of fluidic container with a piercing tip of an elongate probe body. The elongate probe body may include a first end and a second end opposing the first end. The first end may define a piercing tip. The elongate probe body may include a first aperture formed in the elongate probe body proximate the piercing tip. The elongate probe body may include an inner channel extending between the aperture in the first end and the second end. The elongate probe body may be formed of a metal-free polymer matrix and a non-metallic reinforcement material.

In some embodiments, the metal-free polymer matrix may be selected from the group consisting of polyetheretherketone, polyaryletherketone, polyetherketoneketone, polysulfones, polyamides, polycarbonate, acrylic polymers, polyetherimide, polyimides, polyamideimide, liquid crystal polymers, polyesters, acetals, polyphenylene polymers, thermosetting polymers, fluorinated ethylene propylene, ethylene tetrafluoroethylene, polytetrafluoroethylene, perfluoroalkoxy, perfluoroalkoxyethylene, polychlorotrifluoroethylene, polyethylene, polypropylene, polyvinylidene fluoride, or combinations thereof. In some embodiments, the non-metallic reinforcement material may be selected from the group consisting of carbon fibers, glass fibers, basalt fibers, ceramics, talc, mica, or combinations thereof.

In some embodiments, the elongate probe body may have a length of about 1/2 inch to about 12 inches, an outer diameter of about 1/4 inch or less, and an inner diameter of about 1/8 inch or less. In some embodiments, the elongate probe body may include a piercing tip, while in other embodiments the elongate probe body may not include a piercing tip.

### BRIEF DESCRIPTION OF THE DRAWINGS

A further understanding of the nature and advantages of the disclosed technology may be realized by reference to the remaining portions of the specification and the drawings.

FIG. 1 is a fluidic handling system, according to some embodiments of the present technology.

FIG. 2A is a perspective view of a fluidic probe, according to some embodiments of the present technology.

FIG. 2B is a cross-sectional view of the fluidic probe, according to some embodiments of the present technology.

FIG. 2C is a detailed view of the piercing tip of the fluidic probe, according to some embodiments of the present technology.

FIG. 2D is a detailed view of the non-metallic connection system of the fluidic probe, according to some embodiments of the present technology.

FIG. 2E is an exploded view of the non-metallic connection system of the fluidic probe, according to some embodiments of the present technology.

FIG. 3A is a perspective view of an alternate embodiment of a fluidic probe, according to some embodiments of the present technology.

FIG. 3B is a cross-sectional view of the alternative fluidic probe, according to some embodiments of the present technology.

FIG. 4 is a detailed view of an alternate embodiment of a piercing tip of a fluidic probe, according to some embodiments of the present technology.

FIG. 5 is a detailed view of an alternate embodiment of a piercing tip of a fluidic probe, according to some embodiments of the present technology.

FIG. 6 is a simplified diagram showing an embodiment of a method of fluidic handling, according to some embodiments of the present technology.

FIG. 7 is a chart presenting data from a 3-point bend test which compares the bending performance of a fluidic probe according to an embodiment of the present technology with a non-reinforced fluidic probe, according to some embodiments of the present technology.

### DETAILED DESCRIPTION

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present disclosure are directed to fluidic probes and their use in fluidic handling systems. The fluidic probes may provide solutions that enhance strength and durability, while also enabling miniaturization and ensuring bio-compatibility with delicate fluidic samples. For example, the fluidic probes may include an elongate probe body that is formed of a metal-free polymer matrix and a non-metallic reinforcement material. Thus, the fluidic probes may not contain any metallic material in the region that comes in contact with the fluid, and in some embodiments, the fluid probes may not include any metallic material in its entirety. The fluidic probes may offer greater compatibility with delicate fluidic samples, and may reduce the risk of chemical reactivity or contamination. Additionally, the inclusion of a metal-free polymer matrix and a non-metallic reinforcement material may provide improved strength and durability, which may be ideal in piercing applications for preventing buckling and maintaining structural integrity, resisting wear, and performing reliably under mechanical stress or exposure to aggressive fluid. Such features may also enable fluidic probes with smaller diameters and high aspect ratios (high length to diameter ratios). The use of a non-metallic reinforcement material may also provide hybrid rigidity from the reinforcing fillers along with the desirable chemical resistance of the metal-free polymer matrix. The improved rigidity may be thereby accomplished without the use of coatings, which can be inconsistently applied and may wear off over time. Additionally, the non-metallic reinforcement material (e.g., carbon fibers) may provide electrical conductance that can be used for electrostatic discharge (ESD) mitigation or other electrical functions, enabling fluidic handling systems to operate efficiently and safely.

In some embodiments, for the fluidic probe to be biocompatible and metal free, the various components (except where otherwise noted) that may come into contact with the effluent or sample to be analyzed are made of the synthetic polymer polyetheretherketone, which is commercially available under the trademark “PEEK” from Victrex. The polymer PEEK has the advantage of providing a high degree of chemical inertness and therefore biocompatibility; it is chemically inert to most of the common solvents used in fluidic applications, such as acetone, acetonitrile, and methanol (to name a few). PEEK also can be machined by standard machining techniques to provide smooth surfaces. It should be noted that other polymers may be desirable in certain applications. In some aspects, one or more components of a biocompatible fluidic probe may include at least one of polyetheretherketone (PEEK), polyaryletherketone (PAEK), polyetherketoneketone (PEKK), polysulfones (PSU, PESU, PPSU), polyamides (PA), polycarbonate (PC), acrylic polymers (PMMA), polyetherimide (PEI), polyimides (PI), polyamideimide (PAI), liquid crystal polymers (LCP), polyesters (PET, PETG, PBT), acetals (POM), polyphenylene polymers (PPS, PPE, PPO), thermosetting polymers (e.g., vinyl esters and epoxies), fluorinated ethylene propylene (FEP), ethylene tetrafluoroethylene (ETFE), polytetrafluoroethylene (PTFE), perfluoroalkoxy (PFA), perfluoroalkoxyethylene, polychlorotrifluoroethylene (PCTFE), polyethylene (PE), polypropylene (PP), polyvinylidene fluoride (PVDF), or combinations thereof. In any one or more of the foregoing polymers, additional reinforcing fillers or materials may be provided. For example, a fluidic probe according to the present disclosure may include one or more of the above materials in addition to a carbon-fiber material (e.g., carbon-fiber reinforced PEEK), and/or other reinforcing polymeric material, or a combination of some or all of the foregoing. Polymeric materials may include composite or braided materials, such as polymeric materials that include or are braided with fibers such as carbon fibers, basalt fibers, or the like. The reinforcing material may include, but is not limited to, carbon, carbon fibers, or other fibers (e.g., basalt fibers), and may comprise anywhere from between about 10% to 70%, for example but not limited to between about 13% to 67%, between about 15% to 65%, between about 18% to 62%, between about 20% to 60%, between about 23% to 57%, or between about 25% to 55% by weight of the reinforcing material. The fibers may comprise materials that are the same as, or are different from, the polymer or polymer matrix in which the fibers are included.

As used herein, terms such as “fluid,” “fluids,” and “fluidic” are intended to broadly encompass both liquids and gases, as well as any combination thereof, unless explicitly stated otherwise. These terms are not limited to any particular type of fluid or specific fluidic handling application and should be understood in a general sense to include a wide variety of substances may be used in fluidic handling systems. It should therefore be appreciated that the specific type of fluid referenced in any particular embodiment will depend on the context and intended use of the invention, and the use of such terms should not be construed as limiting the scope of the invention to any particular fluid or handling system.

Moreover, as used herein, the term “proximate” is intended to encompass both being at a particular location and being near or in close proximity to a particular location. It should therefore be appreciated that the specific meaning of “proximate” may vary depending on the context of the invention, and it is not limited to an exact location unless explicitly stated. For example, “proximate” may refer to a location within a defined range, such as within a few millimeters, centimeters, or meters in physical distance, or within a defined percentage range of a particular parameter. By way of illustration, “proximate” may include being within ±5% of a specified distance or measurement, depending on the application. Such ranges are provided as examples and should not be considered limiting unless explicitly stated. The scope of “proximate” should be understood in accordance with the principles and objectives of the invention as described herein. The term “about” as used herein when referring to a measurable value such as an amount, encompasses variations of ±5% of the specified value.

Unless defined otherwise, all technical and scientific terms used herein have the same meaning as commonly or conventionally understood. As used herein, the articles “a,” “an,” and “the” refer to one or to more than one (i.e., to at least one) of the grammatical object of the article.

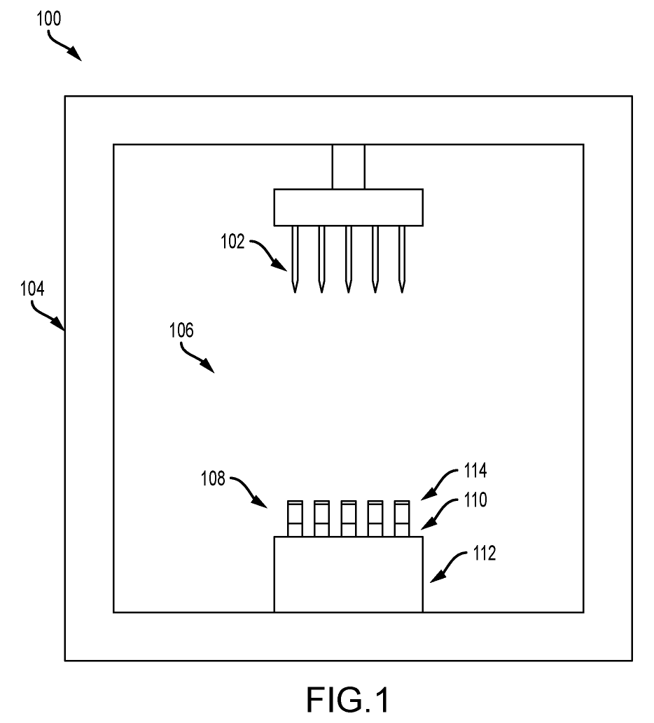

FIG. 1 depicts a fluidic handling system 100. The fluidic handling system 100 may be utilized in a variety of applications and across numerous industries, and may facilitate various aspects of fluidic handling, such as enabling dispensing or aspirating of fluids. For instance, the fluidic handling system 100 may be used in analytical and scientific instruments, including but not limited to in medical diagnostics, such as in blood analysis, urine testing, and disease detection through automated sample handling, and in biotechnology research, including DNA sequencing, PCR preparation, cell sorting, and high-throughput screening. In chemical processing, the fluidic handling system 100 may be utilized for precise mixing, reaction control, and the handling of hazardous or sensitive chemicals, while in pharmaceutical development, the fluidic handling system 100 may facilitate drug formulation, compound screening, and microdosing for clinical trials. Further, in industrial manufacturing, the fluidic handling system 100 may be utilized for fluid dispensing, adhesive application, and lubrication in assembly lines, as well as in microelectronics production, where the fluidic handling system 100 may handle etching solutions, photoresists, and cleaning agents. Similarly, in environmental monitoring, the fluidic handling system 100 may be utilized for water quality testing, pollution detection, and soil sample analysis, and in food and beverage production, the fluidic handling system 100 may assist with flavor mixing, quality control, and ingredient dosing.

Other applications may include laboratory automation, where the fluidic handling system 100 may enable precise liquid handling for sample preparation, reagent dispensing, and microplate filling, and aerospace and automotive industries, where the fluidic handling system 100 may be used in fuel injection testing, hydraulic system prototyping, and cooling system development. In cosmetics manufacturing, for example, the fluidic handling system 100 may help with the precise blending of ingredients and filling of containers, and in clinical settings, the fluidic handling system 100 may support drug delivery systems, IV fluid administration, and automated syringe filling. The fluidic handling system 100 may also be utilized in oil and gas exploration, such as in fluid sampling and analysis, and in academic research, where the fluidic handling system 100 may be utilized for experiments requiring precise fluid control. It should therefore be appreciated that the fluidic handling system 100 may have a wide range of applications, may be configured and/or modified in a variety of ways for a particular application, and is not necessarily limited to the example discussed herein in connection with FIG. 1.

The fluidic handling system 100 may include one or more fluidic probes 102 fixed or removably coupled to a fluidic handling structure 104. The number of fluidic probes 102 included within the fluidic handling system 100 may depend on the particular application. Thus, while five fluidic probes 102 are shown in FIG. 1, it should be appreciated that any number of fluidic probes 102 may be included. The fluidic handling structure 104 may be any type of housing or other enclosure that defines a sampling enclosure 106. The fluidic handling structure 104 may provide structural support while also maintaining environmental control during fluid sampling, such as by minimizing exposure to contaminants, ensuring sterility, or stabilizing temperature-sensitive fluids. The one or more fluidic probes 102 may be fixed or removably coupled to the fluidic handling structure 104 through any suitable connection means, such as tubing, connectors, and fittings, which fluidly connect the one or more fluidic probes 102 to fluidic pathways (not shown) in the fluidic handling system 100.

The fluidic handling system 100 may include one or more fluidic containers 108 within the sampling enclosure 106. The number of fluidic containers 108 included within the sampling enclosure 106 may depend on the particular application. Thus, while five fluidic containers 108 are shown in FIG. 1, it should be appreciated that any number of fluidic containers 108 may be included, and may not necessarily correspond to the number of fluidic probes 102. The one or more fluidic containers 108 may be any container for holding a fluidic sample 110, such as a vial, cartridge, tube, or other suitable container. The one or more fluidic containers 108 may be positioned in a dedicated compartment within the sampling enclosure 106 and/or may be mounted within a fluidic container holder 112. The fluidic container holder 112 may be any suitable holder for securing the one or more fluidic containers 108, such as rack systems, carousels, well plate holders, clamp holders, cartridge holders, slide-in trays, magnetic holders, spring-loaded retainers, custom molded inserts, rotary discs or plates, tube racks, snap-in holders, drawer systems, cryogenic vial holders, integrated fluid pods, clip-on racks, vacuum- or pressure-sealed holders, adjustable slot holders, or robotic-compatible grippers. The one or more fluidic containers 108 and/or the fluidic container holder 112 may be fixed or removable, depending on the particular application.

The one or more fluidic containers 108 may have an open top, or may be partially enclosed, substantially enclosed, or fully enclosed. When partially or fully enclosed, the one or more fluidic containers 108 may include a piercing surface 114, such as a top surface of the one or more fluidic containers 108 (as shown in FIG. 1). The piercing surface 114 may be defined by a membrane, septum, or other pierceable material to facilitate piercing with a fluidic probe 102, accessing of the fluidic sample 110, maintaining sterility, preventing contamination, and/or minimizing evaporation.

The one or more fluidic probes 102 may be moved (e.g., vertically and/or laterally) within the sampling enclosure 106 to allow the one or more fluidic probes 102 to pierce the piercing surface 114 of one or more fluidic containers 108 and contact the fluidic sample 110 therein. Alternatively, the fluidic container holder 112 and/or the one or more fluidic containers 108 may be moved (e.g., vertically and/or laterally) within the sampling enclosure 106 to allow the one or more fluidic probes 102 to pierce the piercing surface 114 of one or more fluidic containers 108 and contact the fluidic sample 110 therein. Fluidic handling, such as the dispensing or aspirating of the fluidic sample 110, may be at least partially managed by a pump or actuator mechanism (not shown), such as a syringe pump, peristaltic pump, or diaphragm pump, that applies controlled pressure or vacuum to drive the fluidic sample 110 through the fluidic handling system 100. The fluidic sample 110 may flow through a network of tubing, channels, or microfluidic pathways (not shown) that fluidly connect the one or more fluidic containers 108 and one or more fluidic probes 102 to various downstream components. Valves (not shown), such as solenoid, rotary, or pinch valves, may be included along these pathways to regulate flow direction, control switching between different fluidic samples 110, or isolate specific sections of the fluidic handling system 100 for maintenance or precision operations. Sensors (not shown), including flow meters, pressure sensors, or liquid level detectors, may also be integrated to monitor fluid movement, detect potential issues, and ensure accurate operation.

Other elements of the fluidic handling system 100 may include tubing, such as biocompatible tubing for liquid chromatography systems, as disclosed and described in U.S. Patent No. 9.056,264. The fluidic handling system 100 may also include biocompatible fitting assemblies and fluidic connection systems, such as those disclosed and described in U.S. Application Serial No. 18,477,095.

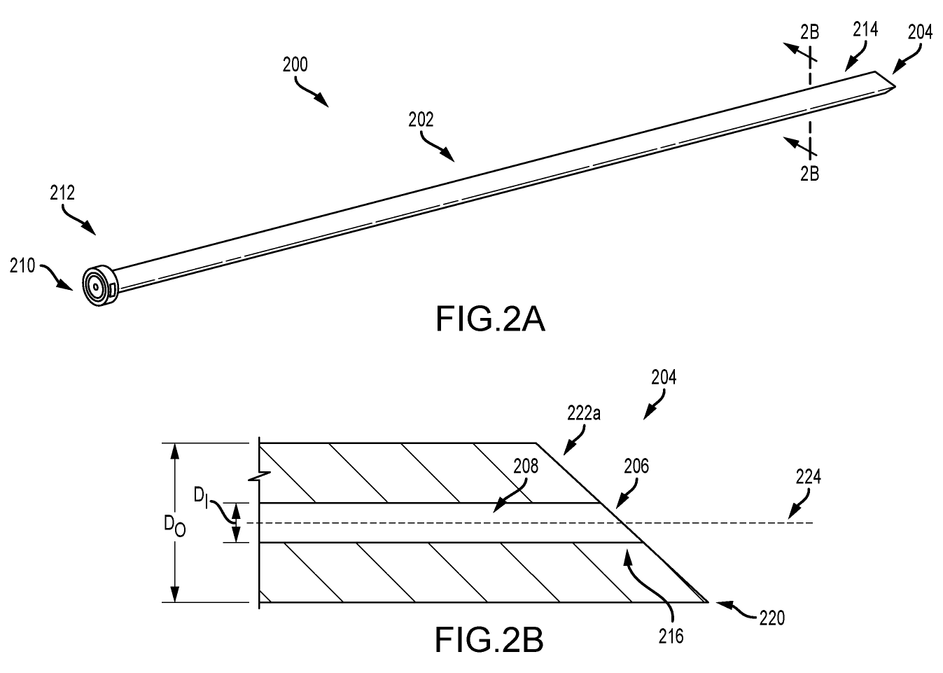

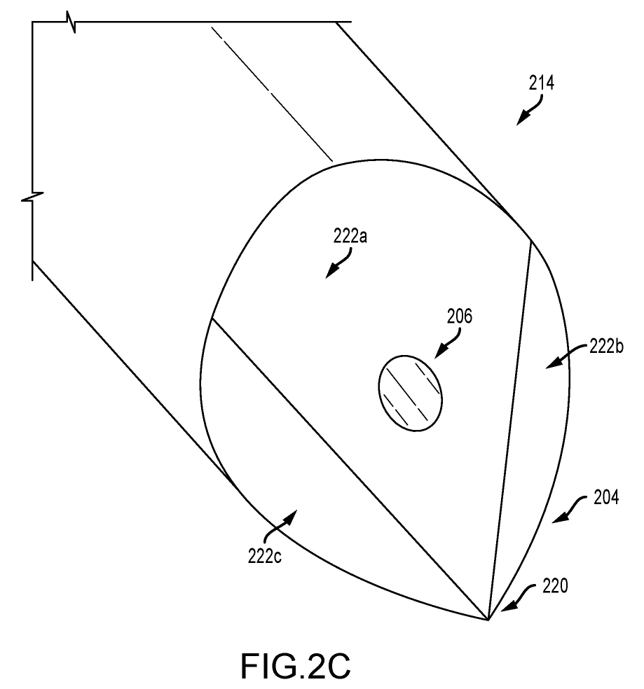

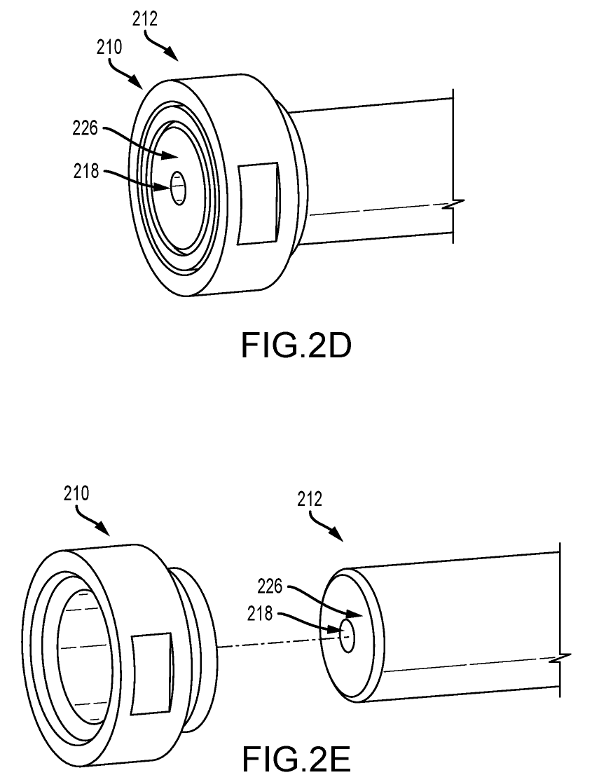

FIGS. 2A-B depict a perspective view and a cross-sectional view of a fluidic probe 200. As will be made apparent by the following disclosure, the fluidic probe 200 may be configured to pierce a surface of fluidic container (shown in FIG. 1) via the piercing tip 204; to handle a fluidic sample (shown in FIG. 1), such as dispensing or aspirating a fluidic sample via the first aperture 206 and inner channel 208; and/or to be removably coupleable to a fluidic system (shown in FIG. 1), such as by a non-metallic connection system 210 coupled to the elongate probe body 202 proximate the second end 212.

The fluidic probe 200 may include an elongate probe body 202. The elongate probe body 202 may have a wide range of shapes, depending on the particular application and intended function. For example, to facilitate piercing a surface of fluidic container, the elongate probe body 202 may have a relatively long and narrow shape. In some embodiments, the elongate probe body 202 may be generally cylindrical. In other embodiments, the elongate probe body 202 may have a different shape, including but not limited to a conical shape, a prismatic shape, a rectangular prism shape, an elliptical shape, a triangular prism shape, a hexagonal prism shape, a tubular shape, a pyramidal shape, a teardrop shape, a bell-shape, an hourglass shape, or other suitable shapes. The elongate body 202 may have a non-tapered, generally uniform shape. Alternatively, the elongate body 202 may form a taper (or other non-uniform feature) along any portion of the elongate body 202, such a taper towards the first end 214, a taper towards the second end 212, or a taper formed therebetween. The fluidic probe 200 may have a length of, for example, between 1“ and 8”, though longer or shorter probes are contemplated within the scope of the present disclosure. The fluidic probe 200 may have an outer diameter Dₒ of 1/8 inch or less. For example, the fluidic probe 200 may have an outer diameter Dₒ of between about 1/32 inch and about 1/4 inch, including but not limited to about 1/32 inch and about 3/16 inch,

The elongate probe body 202 may include a first aperture 206 formed in the elongate probe body 202 proximate the piercing tip 204. The first aperture 206 may facilitate various aspects of fluidic handling, such as enabling dispensing or aspirating of fluids, improving fluid flow dynamics, and/or increasing precision. The first aperture 206 may vary in shape and size, depending on the particular application. For example, the first aperture 206 may be circular, oval (shown in FIG. 2C), rectangular, square, triangular, trapezoidal, crescent-shaped, V-shaped, U-shaped, irregular, hourglass-shaped, arc-shaped, kidney-shaped, or teardrop-shaped. Additionally, an inner diameter D_{I} of the fluidic probe 200, corresponding to the diameter of the first aperture 206, may be between about 0.010 inch and 3/16 inch, for example but not limited to a D_{I} of between about 0.020 inch and about 0.125 inch, between about 1/24 inch and about 3/32 inch, between about 1/16 inch and about 1/8 inch, between about 0.09 inch and about 3/16 inch, and between about 0.12 inch and about 1/4 inch. The location of the first aperture 206 may also vary, depending on the particular application, and may be formed proximate the piercing tip 204 (and/or the first end 214).

The elongate probe body 202 may include an inner sidewall 216 extending from the first aperture 206 along a length of elongate probe body 202 so as to define an inner channel 208 defining a fluid passageway (or lumen) through the elongate probe body 202. The inner channel 208 may facilitate various aspects of fluidic handling, such as enabling dispensing or aspirating of fluids, improving fluid flow dynamics, and/or increasing precision. The inner channel 208 may extend between the first end 214 to the second end 212. For example, as shown in FIGS. 2A-E, the inner sidewall 216 (and thus, the inner channel 208) may extend from the first aperture 206 to the second aperture 218 (shown in FIGS. 2D-E). The inner sidewall 216 may extend in a linear fashion along the length of the elongate probe body 202 (shown in FIG. 2B), or the inner sidewall 216 may extend in a non-linear fashion along the length of the elongate probe body 202. It should therefore be appreciated that the inner channel 208 may have a wide range of shapes, depending on the particular application and intended function. The shape of the inner channel 208 may correspond to the shape of the elongate probe body 202, or it may differ from the shape of the elongate probe body 202. For example, as shown in FIG. 2B, the inner channel 208 may be generally cylindrical so as to correspond to the generally cylindrical shape of the elongate probe body 202. However, the inner channel 208 may have a different shape than the elongate probe body 202, may have a non-uniform shape, may have a non-linear shape, and/or may have a centerline that is colinear or non-colinear from a centerline of the elongate probe body 202.

The elongate probe body 202 further includes a second aperture 218 (shown in FIGS. 2D-E) formed in the elongate probe body 202 proximate the second end 212, and the inner channel 208 may extend from the first aperture 206 to the second aperture 218. The second aperture 218 may facilitate various aspects of fluidic handling, such as enabling dispensing or aspirating of fluids, improving fluid flow dynamics, and/or increasing precision. The second aperture 218 may vary in shape and size, depending on the particular application, and may be substantially the same as the first aperture 206, or may have a different shape and/or size as the first aperture 206. For example, the second aperture 218 may be circular (shown in FIG. 2D), oval, rectangular, square, triangular, trapezoidal, crescent-shaped, V-shaped, U-shaped, irregular, hourglass-shaped, arc-shaped, kidney-shaped, or teardrop-shaped. Additionally, the second aperture 218 may have an inner diameter D_{I} of between about 0.010 inch and 3/16 inch, for example but not limited to a D_{I} of between about 1/32 inch and about 1/20 inch, between about 1/24 inch and about 3/32 inch, between about 1/16 inch and about 1/8 inch, between about 0.09 inch and about 3/16 inch, and between about 0.12 inch and about 1/4 inch. Though a single inner channel (208) is disclosed in the embodiment shown and described in FIGS. 2A-2E, in some embodiment, the elongate probe body 202 may include a plurality of inner channels (i.e. lumens or fluid passageways) through the elongate probe body 202 without departing from the scope of the present disclosure.

The size and relative dimensions of the elongate probe body 202 may vary depending on its particular application and intended function. For example, a length of the elongate probe body 202 may be between about 0.5 inch and 9 inches, for example but not limited to between about 1 inch and 8 inches, between about 1.50 inches and 7.5 inches, between about 2.0 inches and 7 inches, between about 2.5 inches and 6.5 inches, between about 3 inches and 6 inches, between about 3.5 inches and 5.5 inches, or between about 4 inches and 5 inches. An outer diameter Dₒ (or other corresponding lateral dimension) of the elongate probe body 202 may be between about 1/32 inch and about 1/4 inch, for example but not limited to a Dₒ between about 1/32 inch and about 1/16 inch, between about 0.05 inch and about 3/32 inch, between about 0.09 inch and about 1/8 inch, between about 0.12 inch and about 3/16 inch, and between about 0.18 inch and about 1/4 inch. An inner diameter D_{I} (or other corresponding lateral dimension) of the elongate probe body 202 may be between about 0.010 inch and 3/16 inch, for example but not limited to a D_{I} of between about 1/32 inch and about 1/20 inch, between about 1/24 inch and about 3/32 inch, between about 1/16 inch and about 1/8 inch, between about 0.09 inch and about 3/16 inch, and between about 0.12 inch and about 1/4 inch. It should also be appreciated that an inner diameter (or other corresponding lateral dimension) of the first aperture 206, second aperture 218, and/or the inner channel 208 may be substantially the same, or may differ, depending on the particular application. In some embodiments, the elongate probe body 202 may have a length of about 1/2 inch to about 12 inches, an outer diameter Dₒ of about 1/4 inch or less, and an inner diameter D_{I} of about 1/8 inch or less. It should therefore be appreciated that suitable dimensions of the elongate probe body 202 may be selected based on a variety of factors, including manufacturing requirements or limitations; design requirements or limitations, such as forces exerted on the elongate probe body 202 during piercing, the required surface area needed to form the first aperture 206; and/or other factors, such as regulatory considerations.

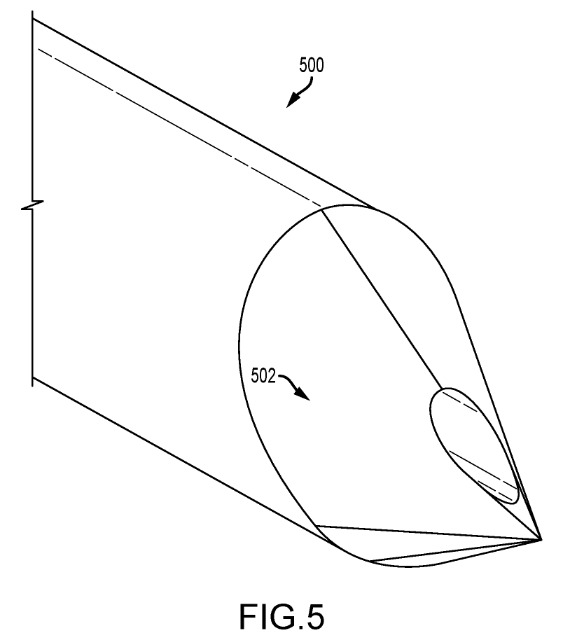

The elongate probe body 202 may be formed of a metal-free polymer matrix and a non-metallic reinforcement material. Thus, the elongate probe body may not contain any metallic material in the region that comes in contact with the fluid, and in some embodiments, the elongate probe body may not include any metallic material in its entirety. The metal-free polymer matrix (e.g., a polymer material) and the non-metallic reinforcement material may provide rigidity to the elongate probe body 202 to reduce bending during use. For example, the elongate probe body 202 may have improved rigidity to provide for improved piercing a fluidic vial seal, with less bending or displacement of the probe during piercing of the seal. As described below with reference to FIG. 5, an elongate probe body 202 in accordance with the present disclosure may have an increase in bend stiffness as compared to a conventional probe body made of natural peek, without the non-metallic reinforcement material.

In some embodiments, the metal-free polymer matrix may include a biocompatible material, for example but not limited to polyetheretherketone (PEEK), polyaryletherketone (PAEK), polyetherketoneketone (PEKK), polysulfones (PSU, PESU, PPSU), polyamides (PA), polycarbonate (PC), acrylic polymers (PMMA), polyetherimide (PEI), polyimides (PI), polyamideimide (PAI), liquid crystal polymers (LCP), polyesters (PET, PETG, PBT), acetals (POM), polyphenylene polymers (PPS, PPE, PPO), thermosetting polymers (e.g., vinyl esters and epoxies), fluorinated ethylene propylene (FEP), ethylene tetrafluoroethylene (ETFE), polytetrafluoroethylene (PTFE), perfluoroalkoxy (PFA), perfluoroalkoxyethylene, polychlorotrifluoroethylene (PCTFE), polyethylene (PE), polypropylene (PP), polyvinylidene fluoride (PVDF), or combinations thereof.

In some embodiments, the non-metallic reinforcement material may be selected from the group consisting of carbon fibers, glass fibers, basalt fibers, or combinations thereof. Further, in some embodiments, the non-metallic reinforcement material may include ceramics, such as silicon carbide and aluminum oxide, or other minerals, such as talc and mica. It should also be appreciated that the non-metallic reinforcement material is not limited to fibers (e.g., carbon fibers discussed in connection with FIG. 5), and may also include other forms, such as particulates, spheres, whiskers, nanotubes, platelets, or other suitable forms. The non-metallic reinforcement material may improve or increase the rigidity of the elongate probe body 202 and may aid increasing the bend stiffness of the elongate probe body 202. The use of non-metallic reinforcement material can provide hybrid rigidity from the reinforcing fillers along with the desirable chemical resistance of the metal-free polymer matrix. The improved rigidity may be thereby accomplished without the use of coatings, which can be inconsistently applied and may wear off over time. In some embodiments, the non-metallic reinforcement material may comprise between about 10% to 70% by weight of the reinforcing material. For example, the non-metallic reinforcement material may comprise between about 13% to 67%, between about 15% to 65%, between about 18% to 62%, between about 20% to 60%, between about 23% to 57%, or between about 25% to 55% by weight of the reinforcing material.

FIG. 2C depicts a detailed view of the piercing tip 204 of the fluidic probe 200, according to some embodiments of the present technology. As shown, the first end 214 of the elongate probe body 202 may define a piercing tip 204. The piercing tip 204 may facilitate various aspects of fluidic handling, such as piercing a surface of fluidic container, improving fluid flow dynamics, and/or increasing precision. The shape of the piercing tip 204 may vary, depending on the particular application. For example, the piercing tip 204 may be conical (shown in FIG. 5), tapered, needle-like, cylindrical, hemispherical, spherical, beveled, chisel-shaped, pyramid-shaped, flat-ended, pointed, rounded, parabolic, ogive-shaped, elliptical, triangular, wedge-shaped, trapezoidal, bullet-shaped, or other suitable shapes. It should be appreciated that in some embodiments of the present disclosure elongate probe body (e.g. 202) may have a non-piercing tip, for example a tip sized and shaped for use with a fluidic container that has an open top, such as an open well plate.

In some embodiments, the piercing tip 204 may be defined by a peak 220 formed by one or more inwardly tapered outer surfaces 222a-c of the elongate probe body 202. The peak 220 may be a singular tip (shown in FIG. 2C) and/or one or more linear edges, depending on the particular shape of the piercing tip 204. The first aperture 206 may be formed in one or more of the inwardly tapered outer surfaces 222a-c. In some embodiments, one or more of the inwardly tapered outer surfaces 222a-c may be generally planar (shown in FIG. 2C). However, one or more of the inwardly tapered outer surfaces 222a-c may also have a non-planar and/or non-uniform surface. Further, in some embodiments, the peak 220 may be offset relative to a longitudinal centerline 224 of the elongate probe body 202. In some embodiments, the peak 220 may be offset relative to a longitudinal centerline of the inner channel 208 (not shown). In either embodiment, and as will be made more apparent by the disclosure, the centerline of the inner channel 208 may be colinear with the longitudinal centerline 224 of the elongate probe body 202 (shown in FIG. 2B), or they may be non-colinear, depending on their respective shape, size, and/or relative positioning.

The size and relative dimensions of the piercing tip 204 may vary, depending on the particular application. For example, the piercing tip 204 may occupy at least 1 percent of the overall length of the elongate probe body 202, at least 2 percent of the overall length of the elongate probe body 202, at least 5 percent of the overall length of the elongate probe body 202, at least 5 percent of the overall length of the elongate probe body 202, at least 10 percent of the overall length of the elongate probe body 202, at least 20 percent of the overall length of the elongate probe body 202, or at least 25 percent of the overall length of the elongate probe body 202. A taper angle between one or more of the inwardly tapered outer surfaces 222a-c and a longitudinal axis of the elongate probe body (e.g., longitudinal centerline 224) may be, for example, at least 1 degree, at least 2 degrees, at least 3 degrees, at least 4 degrees, at least 5 degrees, at least 10 degrees, at least 15 degrees, or at least 20 degrees. It should therefore be appreciated that suitable dimensions of the piercing tip 204 may be selected based on a variety of factors, including manufacturing requirements or limitations; design requirements or limitations, such as forces exerted on the elongate probe body 202 during piercing, the required surface area needed to form the first aperture 206; and/or other factors, such as regulatory considerations.

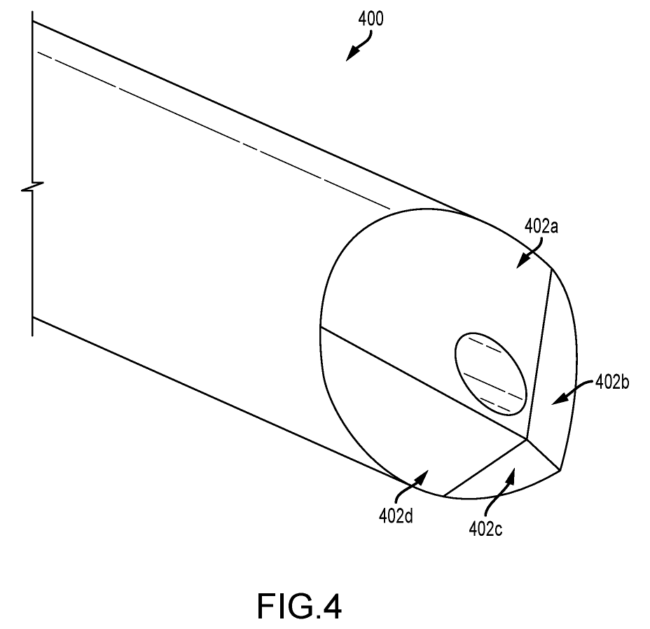

The number of inwardly tapered outer surfaces 222a-c on the elongate probe body 202 may vary depending on the particular application. For example, as shown in FIG. 2C, the elongate probe body 202 may have three generally planar inwardly tapered outer surfaces 222a-c to create a three-facet tip design. Further, as shown in FIG. 4, the elongate probe body 400 may have four three generally planar inwardly tapered outer surfaces 402a-d to create a four-facet tip design. As shown in FIG. 5, the elongate probe body 500 may have a single rounded inwardly tapered outer surface 502 to create a conical tip design. It should therefore be appreciated that the shape of the piercing tip 204 and the number of inwardly tapered outer surfaces 222a-c may be selected based on a variety of factors, including manufacturing requirements or limitations; design requirements or limitations, such as forces exerted on the elongate probe body 202 during piercing, the required surface area needed to form the first aperture 206; and/or other factors, such as regulatory considerations.

FIGS. 2D-2E depict a detailed view and exploded view of a non-limiting exemplary non-metallic connection system 210 of the fluidic probe 200. In some embodiments, the fluidic probe 200 may include a non-metallic connection system 210 coupled to the elongate probe body 202 proximate the second end 212 and configured to removably couple the elongate probe body 202 to a fluidic handling system. The non-metallic connection system 210 may be fixed to the elongate probe body 202, may be removably coupled to the elongate probe body, or may be integral with any portion of the elongate probe body 202. In some embodiments, the non-metallic connection system 210 may be removably coupleable to the elongate probe body 202 proximate the second end 212. The non-metallic connection system 210 may include any system that is non-metallic and suitable for coupling the elongate probe body 202 to a fluidic handling system, such as threaded connections, Luer lock fittings, barbed connectors, press-fit connections, quick-connect couplings, compression fittings, flange connections, adhesive bonding, clamp-style connectors, magnetic couplings, snap-fit connectors, bayonet mounts, twist-lock mechanisms, O-ring seal connections, gasketed joints, heat-sealed interfaces, welded joints, crimped connections, push-to-connect fittings, and modular manifold systems. In some embodiments, the non-metallic connection system 210 may include the connection system discussed in U.S. Application Serial No. 18,477,095.

It should be appreciated that the second end 212 may be shaped, sized, or otherwise configured in a variety of ways, depending on the particular application. For example, the second end 212 may be conical, tapered, needle-like, cylindrical, hemispherical, spherical, beveled, chisel-shaped, pyramid-shaped, flat-ended, pointed, rounded, parabolic, ogive-shaped, elliptical, triangular, wedge-shaped, trapezoidal, bullet-shaped, or other suitable shapes. The second end 212 may also have a tapered, non-tapered, uniform, or non-uniform surface. Additionally, the second end 212 (or other portion of the elongate probe body 202) may be configured to facilitate coupling with a fluidic handling system via the non-metallic connection system 210. For example, as shown in FIGS. 2D-2E, the second end 212 may include a generally planar surface 226, a second aperture 218 may be formed in the generally planar surface 226, and the inner channel 208 (shown in FIG. 2B) may extend from the first aperture 206 (shown in FIG. 2B) to the second aperture 218. Such a configuration may facilitate coupling with the fluidic handling system via the non-metallic connection system 210 shown in FIGS. 2D-2E. Nevertheless, it should be appreciated that the second end 212 may be configured in a variety of ways, depending on the application, and (if included) the particular type of connection system used.

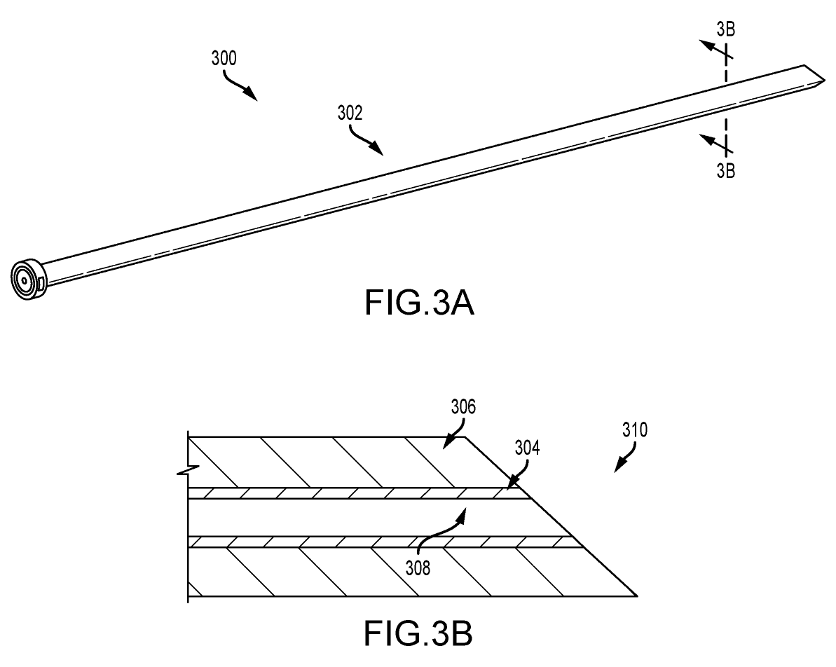

FIGS. 3A-B depict a perspective view and a cross-sectional view of an alternate embodiment of a fluidic probe 300. The fluidic probe 300 may include an elongate probe body 302. The fluidic probe 300 and elongate probe body 302 may be analogous to those discussed in connection with FIGS. 2A-B; however, in some embodiments, the elongate probe body 302 may include an inner body 304 coupled to an outer body 306, and the inner body 304 and the outer body 306 may form a multi-layered structure. The outer body 306 may include a reinforced metal-free ploymer formed of a metal-free polymer matrix in combination with a non-metallic reinforcement material, such as those already discussed in connection with FIGS. 2A-E. The inner body 304 may be formed of an inert bio-compatible and non-metallic material that may not be a reinforced material. For example, the inner body 304 may comprise a polymer material that does not include a non-metallic reinforcement material. In some embodiments, the inert bio-compatible material may include polyetheretherketone; polyaryletherketone; polyetherketoneketone; fluorinated ethylene propylene; ethylene tetrafluoroethylene; polytetrafluoroethylene; perfluoroalkoxy; perfluoroalkoxyethylene; polychlorotrifluoroethylene; polyolefins, such as polyethylene (PE) and polypropylene (PP); polyimides, such as polyimide (PI); polyvinylidene fluoride (PVDF); or combinations thereof. The inner body 304 may form the inner sidewall 308 of the elongate probe body 302. In some embodiments, the inner body 304 may be at least partially insertable into the outer body 306. The inner body 304 may be fixed or removably coupled to the outer body 306.

The fluidic probes discussed herein (e.g.., fluidic probe 200, fluidic probe 300) may be manufactured using a variety of techniques, including polymer extrusion, tip machining, and/or direct injection molding. For example, the fluidic probe 200 (shown in FIGS. 2A-E) may be manufactured through polymer extrusion, followed by tip machining. In the extrusion process, a non-metallic polymeric material (such as those discussed herein) may be melted and shaped through a die. After cooling, the material may be cut to the desired size or length, and may optionally undergo additional post-processing, such as tip machining to create the piercing tip 204. Additionally, the fluidic probe 300 (shown in FIGS. 3A-B) with the inner body 304 and the outer body 306 may be manufactured using similar techniques. For example, the inner body 304 and the outer body 306 may be manufactured through polymer extrusion, either individually, where the inner body 304 may be subsequently inserted within the outer body 306, or by using a co-extrusion process through a single die to form a multi-layered structure. The piercing tip 310 may be created by tip machining, or by over-molding, where molten polymer is injected over the probe’s end to create the tip in a mold. In some embodiments, the piercing tip 310 created via over-molding may be attached to the elongate probe body 302 by using retaining features, such as those discussed in U.S. Patent No. 9,056,264.

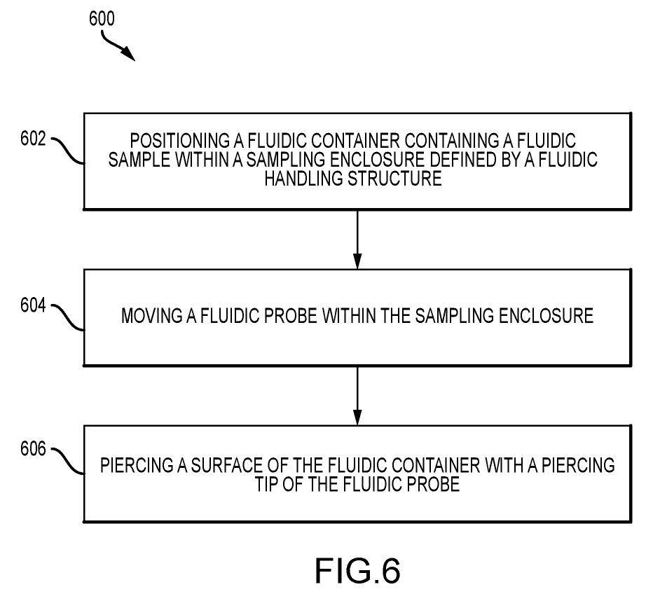

FIG. 6 depicts a simplified diagram showing an embodiment of a method 600 of fluidic handling, and may be applied in a variety of applications, such as those already discussed herein. The method may include, at block 602, positioning a fluidic container containing a fluidic sample within a sampling enclosure defined by a fluidic handling structure. The fluidic container, fluidic sample, sampling enclosure, and fluidic handling structure may correspond to those discussed herein in connection with FIG. 1. The method may further include, at block 604, moving a fluidic probe within the sampling enclosure. The fluidic probe may correspond to those discussed herein in connection with FIGS. 1, 2A-E, 3A-2, 4. and/or 5. Additionally, as explained earlier, in some embodiments, block 604 may alternatively include moving the fluidic container within the sampling enclosure. The method may further include, at block 606, piercing a surface of the fluidic container with a piercing tip of the fluidic probe. The surface may correspond to the piercing surface discussed herein in connection with FIG. 1, and the piercing tip may correspond to those discussed herein in connection with FIGS. 2A-C. 4, and/or 5.

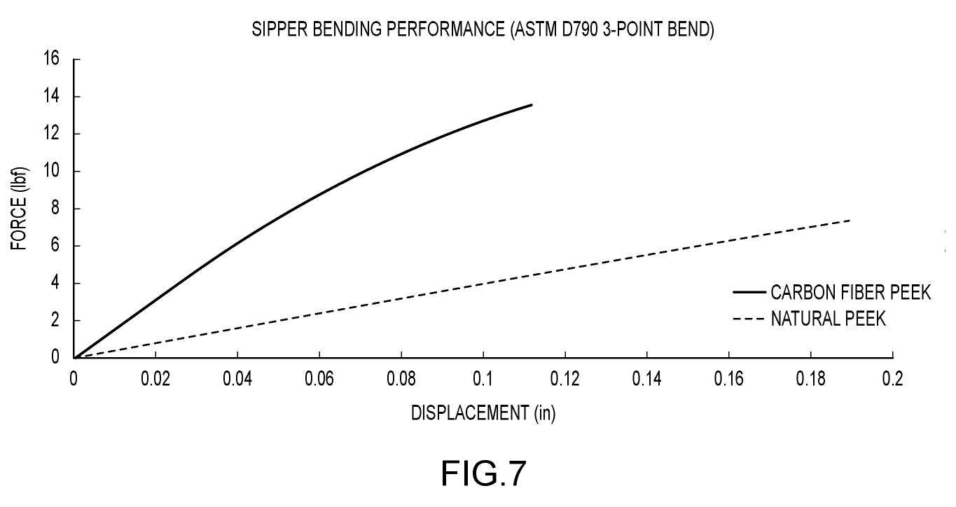

FIG. 7 depicts a chart presenting data from a 3-point bend test which compares the bending performance of a fluidic probe (“sipper”) according to an embodiment of the present disclosure directed to a fluidic probe comprising metal-free polymer matrix and non-metallic reinforcement material as compared to a non-reinforced fluidic probe (e.g. a fluidic probe comprising a metal-free polymer matrix but without non-metallic reinforcement material). Specifically, the chart compares the bending performance of a probe made from carbon fiber reinforced polyetheretherketone (PEEK) with a conventional probe made from natural PEEK (without carbon fibers). The testing was performed in accordance with ASTM D790-17, Standard Test Methods for Flexural Properties of Unreinforced and Reinforced Plastics and Electrical Insulating Materials, published by ASTM International in 2017, which is hereby incorporated by reference in its entirety for all purposes. The ASTM D790-17 3-point bend test is a standardized method for determining the flexural properties of materials by placing a specimen on supports and applying force at the midpoint until it bends or fractures. The y-axis of the graph represents force (measured in pounds-force, lbf), while the x-axis shows displacement (inches). This test provides insights into the material’s stiffness, strength, and resistance to deformation under load. Generally, materials with higher force values for the same displacement exhibit greater bending strength and stiffness. As presented by the chart, the carbon fiber reinforced PEEK probe exhibits higher force values for the same displacement, and thus, exhibits a significant increase in bending strength and stiffness. Additionally, the carbon fiber reinforced PEEK probe exhibits a flexural strength of about 13 lbf, and a displacement of about 0.15 in before failure.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A fluidic probe, comprising:
an elongate probe body, comprising:
a first end and a second end opposing the first end, wherein the first end defines a piercing tip;
a first aperture formed in the elongate probe body proximate the piercing tip; and
an inner channel extending between the first end and the second end, wherein the elongate probe body is formed of a metal-free polymer matrix and a non-metallic reinforcement material.

2. The fluidic probe of claim 1, wherein:
the metal-free polymer matrix is selected from the group consisting of polyetheretherketone, polyaryletherketone, polyetherketoneketone, polysulfones, polyamides, polycarbonate, acrylic polymers, polyetherimide, polyimides, polyamideimide, liquid crystal polymers, polyesters, acetals, polyphenylene polymers, thermosetting polymers, fluorinated ethylene propylene, ethylene tetrafluoroethylene, polytetrafluoroethylene, perfluoroalkoxy, perfluoroalkoxyethylene, polychlorotrifluoroethylene, polyethylene, polypropylene, polyvinylidene fluoride, or combinations thereof.

3. The fluidic probe of claim 2, wherein:
the non-metallic reinforcement material is selected from the group consisting of carbon fibers, glass fibers, basalt fibers, ceramics, talc, mica, or combinations thereof.

4. The fluidic probe of claim 1, wherein:
the non-metallic reinforcement material comprises between about 5% and about 70% by weight of the elongate probe body.

5. The fluidic probe of claim 1, further comprising:
a non-metallic connection system coupled to the elongate probe body proximate the second end and configured to removably couple the elongate probe body to a fluidic handling system.

6. The fluidic probe of claim 1, wherein:
the elongate probe body has a length of about 1/2 inch to about 12 inches, an outer diameter of about 1/4 inch or less, and an inner diameter of about 1/8 inch or less.

7. The fluidic probe of claim 1, wherein:
the elongate probe body has an outer diameter of between about 1/32 inch and about 1/4 inch.

8. The fluidic probe of claim 1, wherein:
the elongate probe body has an inner diameter of between about 0.010 inch and about 3/16 inch.

9. The fluidic probe of claim 1, wherein:
the elongate probe body comprises an inner body coupled to an outer body, wherein:
the outer body comprises the metal-free polymer matrix and the non-metallic reinforcement material;
the inner body defines the inner channel; and
the inner body comprises an inert bio-compatible material.

10. The fluidic probe of claim 9, wherein:
the inner body is at least partially insertable into the outer body.

11. The fluidic probe of claim 9, wherein:
the inert bio-compatible material is selected from the group consisting of polyetheretherketone, polyaryletherketone, polyetherketoneketone, polysulfones, polyamides, polycarbonate, acrylic polymers, polyetherimide, polyimides, polyamideimide, liquid crystal polymers, polyesters, acetals, polyphenylene polymers, thermosetting polymers, fluorinated ethylene propylene, ethylene tetrafluoroethylene, polytetrafluoroethylene, perfluoroalkoxy, perfluoroalkoxyethylene, polychlorotrifluoroethylene, polyethylene, polypropylene, polyvinylidene fluoride, or combinations thereof.

12. The fluidic probe of claim 11, wherein:
the non-metallic reinforcement material is selected from the group consisting of carbon fibers, glass fibers, basalt fibers, ceramics, talc, mica, or combinations thereof.

13. The fluidic probe of claim 1, wherein:
the elongate probe body has a flexural strength of about 13 lbf, as determined by ASTM D790-17 three-point bend testing.

14. The fluidic probe of claim 1, wherein:
the elongate probe body tolerates a displacement of about 0.15 in before failure, as determined by ASTM D790-17 three-point bend testing.

15. A fluidic handling system, comprising:
an elongate probe body removably coupled to a fluid handling structure, the elongate probe body comprising:
a first end and a second end opposing the first end, wherein the first end defines a piercing tip;
a first aperture formed in the elongate probe body proximate the piercing tip; and
an inner channel extending between the first end and the second end, wherein the elongate probe body is formed of a metal-free polymer matrix and a non-metallic reinforcement material.

16. The fluidic handling system of claim 15, wherein:
the metal-free polymer matrix is selected from the group consisting of polyetheretherketone, polyaryletherketone, polyetherketoneketone, polysulfones, polyamides, polycarbonate, acrylic polymers, polyetherimide, polyimides, polyamideimide, liquid crystal polymers, polyesters, acetals, polyphenylene polymers, thermosetting polymers, fluorinated ethylene propylene, ethylene tetrafluoroethylene, polytetrafluoroethylene, perfluoroalkoxy, perfluoroalkoxyethylene, polychlorotrifluoroethylene, polyethylene, polypropylene, polyvinylidene fluoride, or combinations thereof.

17. The fluidic handling system of claim 16, wherein:
the non-metallic reinforcement material is selected from the group consisting of carbon fibers, glass fibers, basalt fibers, ceramics, talc, mica, or combinations thereof.

18. The fluidic handling system of claim 15, wherein:
the elongate probe body has a length of about 1/2 inch to about 12 inches, an outer diameter of about 1/4 inch or less, and an inner diameter of about 1/8 inch or less.

19. A method of fluidic handling, comprising:
piercing a surface of fluidic container with a piercing tip of an elongate probe body, the elongate probe body comprising:
a first end and a second end opposing the first end, wherein the first end defines a piercing tip;
a first aperture formed in the elongate probe body proximate the piercing tip; and
an inner channel extending between the first end and the second end, wherein the elongate probe body is formed of a metal-free polymer matrix and a non-metallic reinforcement material.

20. The method of claim 19, wherein:
the metal-free polymer matrix is selected from the group consisting of polyetheretherketone, polyaryletherketone, polyetherketoneketone, polysulfones, polyamides, polycarbonate, acrylic polymers, polyetherimide, polyimides, polyamideimide, liquid crystal polymers, polyesters, acetals, polyphenylene polymers, thermosetting polymers, fluorinated ethylene propylene, ethylene tetrafluoroethylene, polytetrafluoroethylene, perfluoroalkoxy, perfluoroalkoxyethylene, polychlorotrifluoroethylene, polyethylene, polypropylene, polyvinylidene fluoride, or combinations thereof.

21. The method of claim 20, wherein:
the non-metallic reinforcement material is selected from the group consisting of carbon fibers, glass fibers, basalt fibers, or combinations thereof.

22. The method of claim 19, wherein:
the elongate probe body has a length of about 1/2 inch to about 12 inches, an outer diameter of about 1/4 inch or less, and an inner diameter of about 1/8 inch or less.
